(19) United States
(12) Patent Application Publication
(10) Pub. No.: US 2024/0344605 A1
(43) Pub. Date: Oct. 17, 2024

(54) METHOD FOR CONTROLLING AN OPERATION OF A GEAR MECHANISM OF A MOTOR VEHICLE

(71) Applicant: ZF Friedrichshafen AG, Friedrichshafen (DE)

(72) Inventors: Fabian HARTMANN, Hettstadt (DE); Norman SCHMIDT-WINKEL, Kürnach (DE); Florian MÜHLFELD, Kürnach (DE); Ludwig GEIßELBRECHT, Sachsen b. Ansbach (DE)

(21) Appl. No.: 18/633,653

(22) Filed: Apr. 12, 2024

(30) Foreign Application Priority Data
Apr. 13, 2023 (DE) 10 2023 203 342.9

(51) Int. Cl. F16H 61/04; B60K 17/02; B60L 15/20

(52) U.S. Cl. CPC F16H 61/0403; B60K 17/02; B60L 15/20; B60W 10/02; B60W 10/08; B60L 2240/421; B60L 2240/423; B60W 2510/081; B60W 2510/083; B60W 2520/10; B60W 2710/021; B60W 2710/081; B60W 2710/083; F16H 2061/044; F16H 2061/0488

(57) ABSTRACT

A method for controlling an operation of the gear mechanism of a motor vehicle having a freewheel device coupled to an electrical machine and configured to couple the electrical machine rotation speed-dependently to an output of the freewheel device or decouple it therefrom. The gear mechanism depending on a state change signal, starting from a decoupled state of the freewheel device, is operated in a pre-synchronization phase in which the rotation speed of the electrical machine is regulated to a target rotation speed, in particular below an actual rotation speed of the output, and on reaching a nominal rotation speed below the target rotation speed, a coupling phase is implemented in which the target rotation speed is increased and the transition to the coupled state of the freewheel device is performed.

### BACKGROUND OF THE INVENTION

### 1. Field of the Invention

The disclosure concerns a method for controlling an operation of a gear mechanism of a motor vehicle, comprising a freewheel device coupled to an electrical machine and configured to couple the electrical machine rotation speed-dependently to an output of the freewheel device or decouple it therefrom.

### 2. Description of Related Art

Methods for controlling the operation of gear mechanisms of motor vehicles, having an electrical machine which, by a freewheel device, can optionally be coupled to the output of the freewheel device or decoupled therefrom, are known in principle from the prior art. Such gear mechanisms may for example be used in all-wheel drive vehicles in the form of so-called “hang-on” systems. In general, the electrical machine may be coupled in only when torque is to be supplied from the electrical machine to the output. In other driving states in which the electrical machine is not to be used, it can be decoupled via the freewheel device so that drag losses can be reduced and hence the efficiency of the vehicle improved.

When using freewheel devices, i.e. in mechanical overrun, coupling or decoupling of the electrical machine can be achieved automatically depending on the current movement state, in particular depending on the rotation speed of the input side of the freewheel, which is coupled to the electrical machine, and of the output side of the freewheel. Here however, it must be considered that when the electrical machine is coupled in, the freewheel switches from the decoupled state to the coupled state, wherein such a change of state—which is normally torque-controlled, since a specific desired torque is required from the electrical machine, which is then provided by the electrical machine—leads to a jerky torque transmission on closure of the freewheel. Such a jerky closure has a negative effect on comfort and hence acceptance by the user of the motor vehicle, in particular in scenarios in which such state changes occur frequently.

### SUMMARY OF THE INVENTION

One aspect of the invention is based on the object of indicating an improved method for controlling an operation of a gear mechanism of a motor vehicle.

As stated, one aspect of the invention concerns a method for controlling an operation of a gear mechanism of a motor vehicle. The gear mechanism comprises an electrical machine which is coupled to a freewheel device. The electrical machine can be coupled to an input side or drive side of the freewheel device. At least one translation stage may be provided between the electrical machine and the freewheel device. Accordingly, it is possible for the rotation speed of the electrical machine, e.g. the rotor rotation speed, to be transmitted directly to the freewheel device or translated by at least one translation stage.

The coupling between the electrical machine and the output of the freewheel device, e.g. a driven wheel of the motor vehicle, is thus created rotation speed-dependently. A coupling is created between the output and the electrical machine when the rotation speed of the input side of the freewheel device, to which the electrical machine is coupled, reaches the rotation speed of the output side. In principle, any arbitrary freewheel device may be used as a freewheel device. For example, a switchable freewheel device, or a freewheel device in which the direction of action can be switched, may be used. As described, the freewheel device may be arranged directly at or on the rotor shaft, or be connected thereto. Alternatively, at least one translation stage may be arranged between the rotor shaft and the freewheel device. The freewheel device may for example also be arranged on a side shaft of a differential gear.

One aspect of the invention is based on the knowledge that the gear mechanism, in particular depending on a state change signal, starting from a decoupled state of the freewheel device, is operated in a pre-synchronization phase in which the rotation speed of the electrical machine is regulated to a target rotation speed lying in particular below an actual rotation speed of the output, and on reaching a nominal rotation speed below the target rotation speed, a coupling phase is implemented in which the target rotation speed is increased and the transition to the coupled state of the freewheel device is performed.

One aspect of the invention thus proposes performing a defined transition of the freewheel device from the decoupled state to the coupled state, instead of operating the freewheel device purely movement-dependently and hence effectively uncontrolledly. This offers the advantage that the coupled state can be assumed in defined fashion, and during the coupling phase, a defined transition can be carried out in which a jerky closure of the freewheel device can be prevented. Negative effects on acceleration or comfort, and hence acceptance by the user, can therefore be avoided.

According to the method described herein, a state change signal may be generated when the system is to transfer from the decoupled state to the coupled state. The state change signal may generally also be called a trigger. The state change signal may for example be a driving state which requires use of the electrical machine. Also, as a state change signal, a torque request, a drive pedal position or other parameters or state variables may be used.

The method provides in particular that for transition from the decoupled state to the coupled state, initially a pre-synchronization phase is performed. During the pre-synchronization phase, the rotation speed of the electrical machine, in particular the rotor shaft, is regulated. In the pre-synchronization phase, in particular it is regulated to the set (constant) target rotation speed. The target rotation speed may be set depending on the output rotation speed. The pre-synchronization phase is implemented in particular to bring the rotation speed of the electrical machine—perhaps translated into the speed of the input side of the freewheel device—to the actual rotation speed of the output as quickly as possible, but not actually reach this and not exceed it. In the pre-synchronization phase, it is therefore ensured that no unintentional premature closure of the freewheel device—and hence uncontrolled generation of a jerky transition—takes place.

The described coupling phase is therefore implemented already when the electrical machine or input side of the freewheel device reaches a nominal rotation speed which lies below the previously established target rotation speed and hence below the actual rotation speed of the output. The nominal rotation speed may for example lie below the actual rotation speed by a defined offset, so that starting from the nominal rotation speed, it is firstly ensured that no uncontrolled transition to the coupled state is performed, and secondly it is ensured that the rotation speed is already adequately balanced. When the nominal rotation speed is reached, in the coupling phase the previously established target rotation speed is increased, in particular continuously, so that a further rise in rotation speed is carried out. This rotation speed-controlled performance of the state transition prevents a jerky, uncontrolled closure.

In the method, it may be provided that the target rotation speed is set depending on the rotation speed of the output of the freewheel device, in particular higher or lower than the rotation speed of the output, and the nominal rotation speed is set lower than the rotation speed of the output. As described, the target rotation speed may be mainly used for a rotation speed regulation of the electrical machine, in order to bring the rotation speed of the electrical machine or input of the freewheel device to the rotation speed of the output. Depending on the rotation speed of the output, firstly a target rotation speed may be defined above the rotation speed of the output, for example to ensure that the rotation speeds are balanced as quickly as possible. Alternatively, the target rotation speed may also be set below the rotation speed of the output. Since the target rotation speed is in any case not reached or exceeded in the pre-synchronization phase, during selection or setting of the target rotation speed, the focus may be primarily on balancing the rotation speeds.

To prevent the target rotation speed being reached, the nominal rotation speed lies below the output rotation speed, so that—as described above—on reaching the nominal rotation speed, the coupling phase can be implemented so that the defined controlled transition from the decoupled state to the coupled state can be performed. Finally, the target rotation speed and the nominal rotation speed may thus each be understood as an offset established independently of one another.

In a refinement of the method, it may be provided that the target rotation speed is supplied filtered to the electrical machine. Instead of a sharp jump or non-constant function, the target rotation speed can be supplied filtered to the electrical machine. For this, in principle any filters may be used, e.g. a known PT1 filter. As described, the target rotation speed may be set depending on speed or rotation speed. The target rotation speed may for example be defined depending on the rotation speed control of the drive device.

As already described, the actual coupling phase should be implemented on reaching the nominal rotation speed, i.e. the transition from the decoupled state to the coupled state should be deliberately shifted into the described coupling phase and performed there. Here, on reaching the nominal rotation speed, the change in target rotation speed may be performed using a linear gradient. Since the electrical machine is directly or indirectly coupled to the input side of the freewheel device, the rotation speed of the electrical machine (e.g. of the rotor shaft) and the rotation speed of the input side of the freewheel device can be transferred to one another arbitrarily, or be identical, depending on translation ratio. In the context of this application therefore, the rotation speed regulation always applies to the rotation speed of the electrical machine or the rotation speed of the input side of the freewheel device used, and the description transferred accordingly.

By using the linear gradient, the rotation speed of the electrical machine—which is always guided to the target rotation speed—is increased linearly to ensure that the rotation speeds of the input side and output side of the freewheel device can be balanced to one another in defined fashion and a jerky transition prevented. During the coupling phase, the input side of the freewheel device assumes the rotation speed of the output, wherein the freewheel device then closes. Then the target rotation speed may be further increased so that effectively torque can be transferred between the electrical machine and the output.

The method may be refined in that after the coupling phase, in a transitional phase after reaching a defined torque threshold, the rotation speed control is ended and a torque control is applied. As described, in the coupling phase it is definitely ensured that transition may take place from the decoupled state to the coupled state. The coupling phase may thus be carried out completely controlled or regulated by rotation speed. To further regulate the gear mechanism or electrical machine, a torque threshold is set, wherein the torque transmitted via the freewheel device can be monitored.

When the torque threshold is exceeded, the rotation speed control is ended and a torque control applied. The torque threshold may lie at comparatively low torque levels, depending on the actual gear mechanism, in a range between 1 Nm and 50 Nm, in particular between 5 Nm and 25 Nm. As soon as the torque threshold is reached, it is ensured that the freewheel device is engaged and closed, so that from then on a torque control can be applied, e.g. to a desired target torque. The described torque threshold may also be set depending on rotation speed.

After the coupling phase, therefore in the transitional phase after reaching a defined torque threshold, the rotation speed control is ended and a torque control applied. The torque threshold may for example be set depending on rotation speed. Thus firstly rotation speed-dependently, the coupling of the freewheel device is performed until a torque amounting to the defined torque threshold is transmitted. Then the rotation speed control is ended and the torque control applied.

In the described transitional phase, a torque transmitted by the electrical machine via the freewheel device can be increased to a target torque using a torque gradient. The target torque may for example be torque required for driving operation, a desired torque or any other torque. Since the defined transition of the freewheel device to the coupled state was already performed in the coupling phase, and the torque threshold ensures that the freewheel device is definitely closed, in the transitional phase then any torque gradient may be used, since the coupling was already created in the coupling phase and hence a jerky transition prevented. For example, since the coupled state was created in the coupling phase and the target torque reached in the transition phase, the target torque may be used for driving.

Furthermore, in the method it may be provided that in the coupled state, a holding phase or holding state is implemented, wherein by the electrical machine, independently of a target torque, an actual torque which is greater than an established nominal torque is transmitted to the output by the freewheel device. Since various target torque levels can be set beyond the driving mode of the motor vehicle or gear mechanism, and depending on driving situation, the target torque may be reduced even to zero, uncontrolled changes of state of the freewheel device would occur since this would be decoupled and recoupled again uncontrolledly. Here it may be provided that a holding state is implemented in which the freewheel device is kept closed under control. For this, a nominal torque is set and it is ensured that the actual torque transmitted by the freewheel device is always greater than the set nominal torque. This ensures that the freewheel device remains closed and engaged even if the target torque is e.g. briefly reduced to zero. The nominal torque may lie for example in a range from 1 Nm to 10 Nm, to ensure that the freewheel device is closed but no torque is provided which would lead to drive of the motor vehicle. In general, the actual torque may be calculated or considered so as to compensate for drag and friction losses, and for inertia of the electrical machine and partial drive train up to the freewheel device.

As already described, in comparison with the prior art, a controlled transition is performed between the decoupled state and the coupled state, instead of the freewheel device being coupled and decoupled automatically mechanically, and depending purely on the actual rotation speed. Here in particular, it may be provided that the decoupled state is assumed depending on a state change signal, in particular when a target torque lies below the nominal torque for a defined duration. The embodiment thus provides that the above-described holding state or any other coupled state may be ended if a state change signal is produced or received which requires a transition to the decoupled state.

For example, the state change signal may consist of the target torque lying below the nominal torque for a specific duration. Also, other external trigger signals may be used. Then the electrical machine may be switched off for example. The decoupled state of the freewheel device can then be retained until a further state change signal is received which again requires the change to the coupled state. The method described herein with pre-synchronization phase, coupling phase, transitional phase and in some cases holding state, may then be carried out again.

As well as the method, one aspect of the invention concerns a control device for a gear mechanism which is configured to carry out the above-described method. Aspects of the invention furthermore concern a gear mechanism comprising a freewheel device coupled to an electrical machine and configured to couple the electrical machine rotation speed-dependently to an output of the freewheel device or decouple it therefrom, wherein the gear mechanism is configured, in particular depending on a state change signal, starting from a decoupled state of the freewheel device, to operate the electrical machine in a pre-synchronization phase in which the rotation speed of the electrical machine is regulated to a target rotation speed, in particular lying below an actual rotation speed of the output, and on reaching a nominal rotation speed below the target rotation speed, a coupling phase is implemented in which the target rotation speed is increased and the transition to the coupled state of the freewheel device is performed.

One aspect of the invention also concerns a drive train comprising an above-described control device and/or an above-described gear mechanism. One aspect of the invention furthermore concerns a motor vehicle having an above-described control device and/or an above-described gear mechanism and/or an above-described drive train.

All advantages, details and features described in connection with the method can be transferred in full to the motor vehicle, the drive train, the gear mechanism and the control device.

### BRIEF DESCRIPTION OF THE DRAWINGS

The invention is described below with reference to exemplary embodiments and the drawings. The figures are schematic illustrations and show:

FIG. 1 is a general illustration of a motor vehicle;

FIG. 2 is a general illustration of a flow diagram;

FIG. 3 is a general illustration of a state diagram of the motor vehicle; and

FIG. 4 is a general illustration of a state diagram of the motor vehicle.

### DETAILED DESCRIPTION OF THE PRESENTLY PREFERRED EMBODIMENTS

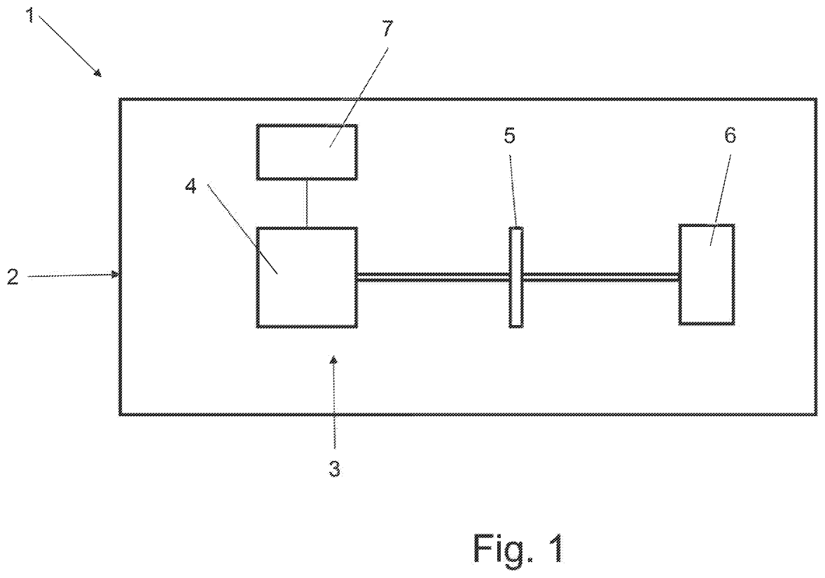

FIG. 1 shows a schematic general illustration of a motor vehicle 1, comprising a drive train 2 with a gear mechanism 3 having an electrical machine 4 and a freewheel device 5. By the freewheel device 5, the electrical machine 4 can optionally be coupled to and decoupled from an output 6 of the gear mechanism 3. The arrangement of the electrical machine 4 or freewheel device 5 should be considered purely as exemplary. Arbitrary translation stages may be provided between the electrical machine 4 and the freewheel device 5. The following description relating to the rotation speed control can thus be transferred to the rotation speed of the electrical machine, e.g. an output shaft or rotor shaft, or to the rotation speed of the input side of the freewheel device 5, or the individual rotation speeds can be transferred into one another on the basis of the actual translation ratios.

As a freewheel device 5, any freewheel device 5 may be used, e.g. a conventional freewheel, a switchable freewheel, or a freewheel device with reversible action direction. As described, the arrangement of the freewheel device 5 inside the gear mechanism 3 or inside the drive train 2 may be selected arbitrarily. For example, the freewheel device 5 may be coupled directly to the rotor shaft of the electrical machine 4 or to another point, e.g. a side shaft of a differential gear.

As evident from FIG. 1, the electrical machine 4 can generate a rotational movement which, depending on the present state of the freewheel device 5, can be transmitted to the output 6 in a coupled state, or a decoupled state may exist in which the electrical machine is decoupled from the output 6.

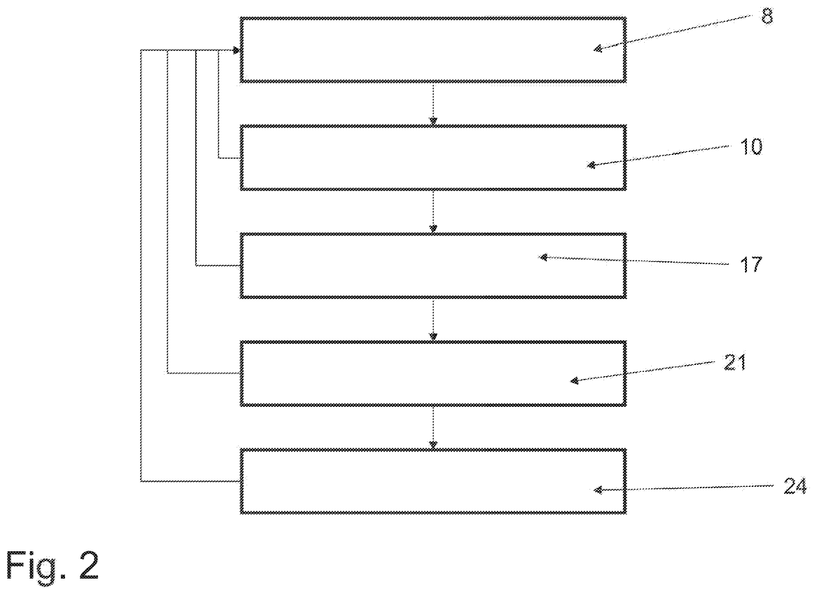

The gear mechanism 3 has a control device 7 configured to control the electrical machine 4. The control device 7 is in particular configured to regulate the rotation speed and torque of the electrical machine 4. The control of the electrical machine 4 by the control device 7 may be divided into various phases. FIG. 2 shows a schematic flow diagram of such a control or regulation of the operation of the electrical machine 4.

Control of the electrical machine 4 is based in particular on a functional separation between the assumption of the decoupled state and the coupled state. This means that the freewheel device 5 is not used uncontrolledly, depending on the actual movement states, but the transitions between the individual states are performed and in some cases held in defined fashion. For this, the control device 7 may work on the basis of state change signals, so that a transfer from a current state to a different state, in particular from the decoupled state to the coupled state or from the coupled state to the decoupled state, is performed only when a corresponding state change signal is received.

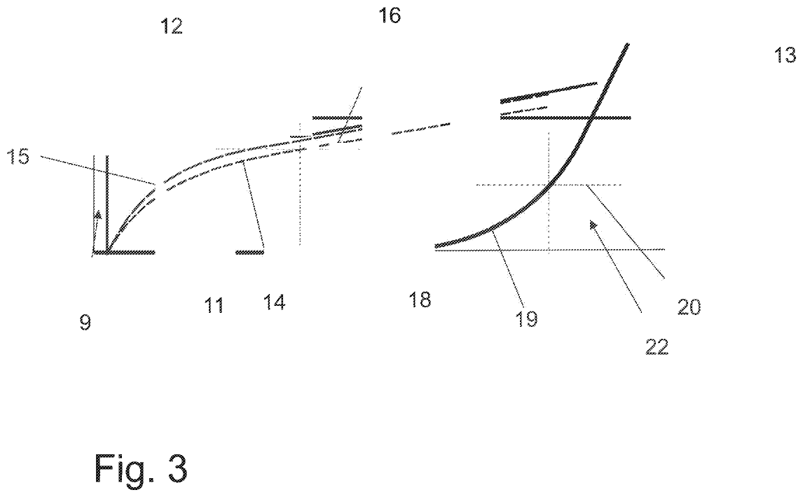

The method may for example start in a block 8 in which a decoupled state exists, i.e. the freewheel device 5 is open. In block 8, purely as an example, a state change signal is generated by or received from the control device which requires transition from a decoupled state to the coupled state. The decoupled state is shown as phase 9 in the exemplary state diagram in FIG. 3.

Here, in block 10, firstly a pre-synchronization phase 11 (FIG. 3) is carried out. In the pre-synchronization phase 11, a target rotation speed 12 is set, in particular as a defined offset relative to an actual rotation speed 13 of the output 6, i.e. the output side of the freewheel device 5. The offset, as shown, may be positive or negative, i.e. the target rotation speed 12 could in principle also lie above the actual rotation speed 13. In the pre-synchronization phase 11, the rotation speed 14 of the electrical machine 4 or the input side of the freewheel device 5 may rise according to an established curve, so as to approach the actual rotation speed 13 of the output 6. Alternatively, a filtered function may be used, e.g. a PT1 filter, as illustrated by a curve 15.

The pre-synchronization phase 11 is implemented until, during the rotation speed regulation, the rotation speed of the input side of the freewheel device 5, or the rotation speed 14 of the electrical machine 4, reaches or exceeds a nominal rotation speed 16. The nominal rotation speed 16 may itself be established depending on the actual rotation speed of the output 6 and is selected so that it lies below the target rotation speed 12.

On reaching the nominal rotation speed 16, the pre-synchronization phase 11 ends and in FIG. 2, block 10 is followed by a block 17 in which a coupling phase 18 is implemented, as illustrated in FIG. 3. In block 17, in the coupling phase 18, the target rotation speed 12 is increased, in particular starting from the nominal rotation speed 16. As FIG. 3 shows, the target rotation speed 12 can be increased using a linear speed gradient. Thus the rotation speed 14 of the electrical machine 4 also increases, and hence with it the rotation speed of the input side of the freewheel device 5. Because of the defined rotation speed gradient, in the coupling phase 18, a controlled transition from the decoupled state to the coupled state is possible. The rotation speed difference between the actual rotation speed 13 of the output 6 and the rotation speed 14 may in particular be selected so small that, on transition to the coupled state, there is no jerky closure of the freewheel device 5, so that acceptance by the user can be improved.

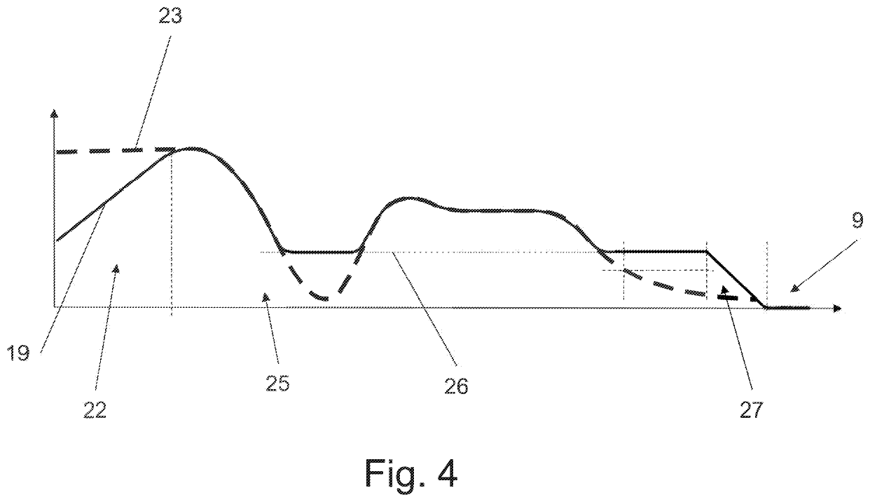

The coupling phase 18 may be ended when an actual torque 19 exceeds a torque threshold 20, e.g. 5 Nm. The actual torque 19 is for example the external torque output by the electrical machine 4 to the freewheel device 5. When considering the actual torque 19, the drag and friction losses in the electrical machine 4 and partial drive train up to the freewheel device 5 may be compensated and inertia eliminated. On ending of the coupling phase 18, the method branches from block 17 to a block 21. In the block 21, a transitional phase 22 is implemented in which the rotation speed control is ended and a torque control applied. Here for example, the torque can be regulated using a defined torque gradient to a target torque 23, which for example may correspond to a driver's desired torque. The target torque 23 is shown as an example in FIG. 4, which also shows a state diagram which may for example follow the state diagram of FIG. 3. When the target torque 23 is reached, the target torque 23 may be used e.g. to drive the motor vehicle 1, and the corresponding target torque 23 used for travel. For the sake of simple illustration, the actual rotation speed 13 and target torque 23 are constant, wherein however these may vary depending on state.

Block 21 in FIG. 2 may be followed by a block 24 in which a holding phase or a holding state 25 is implemented. The holding state 25 is shown for example in FIG. 4. In the holding state 25, a nominal torque 26 is defined which is provided at least by the electrical machine 4 and transmitted via the freewheel device 5, irrespective of the target torque 23 which results for example from the driving strategy or a driver's request. As shown in FIG. 4, in the holding state 25, the actual torque 19 always remains above the nominal torque 26 until a state change signal is received, even if the target torque 23 is below the nominal torque 26. This ensures that the freewheel device 5 remains definitely closed, the coupled state is maintained and hence the freewheel device 5 cannot be opened and closed uncontrolledly, which could lead to jerky behavior.

If a state change signal is received, the process can transfer from the holding state 25 into an open state again, in particular via a decoupling phase 27, so in the diagram of FIG. 2, the method branches from block 24 to block 8. The state change signal may for example—as shown—relate to torque lying below the nominal torque 26 for a specific duration. Then for example the electrical machine 4 may be switched off, whereby the freewheel device 5 opens again and thus, via the decoupling phase 27, transfers back to phase 9 in which the decoupled state exists. On receipt of a further state change signal which requires a transition to the coupled state, the method may be carried out again. As FIG. 2 furthermore shows, the system may also transfer directly from all other states to the decoupled state if a corresponding state change signal is received, e.g. to interrupt the coupling process.

The advantages, details and features shown in the individual exemplary embodiments may be combined arbitrarily with one another, interchanged and transferred to one another.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method for controlling an operation of a gear mechanism of a motor vehicle having a freewheel device coupled to an electrical machine, the freewheel device configured to couple the electrical machine rotation speed-dependently to an output of the freewheel device or decouple the freewheel device from the output, comprising:
operating the gear mechanism, depending on a state change signal, starting from a decoupled state of the freewheel device, in a pre-synchronization phase in which a rotation speed of the electrical machine is regulated to a target rotation speed lying below an actual rotation speed of the output; and
implementing a coupling phase on reaching a nominal rotation speed below the target rotation speed in which the target rotation speed is increased and a transition to a coupled state of the freewheel device is performed.

2. The method as claimed in claim 1, further comprising:
setting the target rotation speed depending on the rotation speed of the output of the freewheel device, one of higher or lower than the rotation speed of the output, and
setting the nominal rotation speed than the rotation speed of the output.

3. The method as claimed in claim 2, wherein the target rotation speed is supplied filtered to the electrical machine.

4. The method as claimed in claim 1, wherein on reaching the nominal rotation speed, a change in target rotation speed is performed using a linear gradient.

5. The method as claimed in claim 1, wherein after the coupling phase, in a transitional phase after reaching a defined torque threshold, rotation speed control is ended and a torque control is applied.

6. The method as claimed in claim 5, wherein in the transitional phase, a torque transmitted by the electrical machine via the freewheel device is increased to a target torque using a torque gradient.

7. The method as claimed in claim 1, wherein in the coupled state, a holding state is implemented, wherein by the electrical machine, independently of a target torque, an actual torque which is greater than an established nominal torque is transmitted to the output by the freewheel device.

8. The method as claimed in claim 1, wherein the decoupled state is assumed depending on the state change signal, when a target torque lies below a nominal torque for a defined duration.

9. A control device for a gear mechanism for a motor vehicle having a freewheel device coupled to an electrical machine, the freewheel device configured to couple the electrical machine rotation speed-dependently to an output of the freewheel device or decouple the freewheel device from the output, wherein the control device is configured to:
operate the gear mechanism, depending on a state change signal, starting from a decoupled state of the freewheel device, in a pre-synchronization phase in which a rotation speed of the electrical machine is regulated to a target rotation speed lying below an actual rotation speed of the output; and
implement a coupling phase on reaching a nominal rotation speed below the target rotation speed in which the target rotation speed is increased and a transition to a coupled state of the freewheel device is performed.

10. A gear mechanism comprising:
a freewheel device coupled to an electrical machine and configured to couple the electrical machine rotation speed-dependently to an output of the freewheel device or decouple it therefrom,
wherein the gear mechanism is configured, depending on a state change signal, starting from a decoupled state of the freewheel device, to operate the electrical machine in a pre-synchronization phase in which a rotation speed of the electrical machine is regulated to a target rotation speed, lying below an actual rotation speed of the output, and on reaching a nominal rotation speed below the target rotation speed, a coupling phase is implemented in which the target rotation speed is increased and a transition to a coupled state of the freewheel device is performed.

11. A drive train comprising at least one of:
a control device for a gear mechanism for a motor vehicle having a freewheel device coupled to an electrical machine, the freewheel device configured to couple the electrical machine rotation speed-dependently to an output of the freewheel device or decouple the freewheel device from the output, wherein the control device is configured to:
operate the gear mechanism, depending on a state change signal, starting from a decoupled state of the freewheel device, in a pre-synchronization phase in which a rotation speed of the electrical machine is regulated to a target rotation speed lying below an actual rotation speed of the output; and
implement a coupling phase on reaching a nominal rotation speed below the target rotation speed in which the target rotation speed is increased and a transition to a coupled state of the freewheel device is performed; and
the gear mechanism comprising:
the freewheel device coupled to the electrical machine and configured to couple the electrical machine rotation speed-dependently to an output of the freewheel device or decouple it therefrom,
wherein the gear mechanism is configured, depending on the state change signal, starting from the decoupled state of the freewheel device, to operate the electrical machine in a pre-synchronization phase in which the rotation speed of the electrical machine is regulated to a target rotation speed, lying below an actual rotation speed of the output, and on reaching the nominal rotation speed below the target rotation speed, the coupling phase is implemented in which the target rotation speed is increased and the transition to the coupled state of the freewheel device is performed.

12. A motor vehicle comprising:
a control device for a gear mechanism for a motor vehicle having a freewheel device coupled to an electrical machine, the freewheel device configured to couple the electrical machine rotation speed-dependently to an output of the freewheel device or decouple the freewheel device from the output, wherein the control device is configured to:
operate the gear mechanism, depending on a state change signal, starting from a decoupled state of the freewheel device, in a pre-synchronization phase in which a rotation speed of the electrical machine is regulated to a target rotation speed lying below an actual rotation speed of the output; and
implement a coupling phase on reaching a nominal rotation speed below the target rotation speed in which the target rotation speed is increased and a transition to a coupled state of the freewheel device is performed; and
the gear mechanism comprising:
the freewheel device coupled to the electrical machine and configured to couple the electrical machine rotation speed-dependently to an output of the freewheel device or decouple it therefrom,
wherein the gear mechanism is configured, depending on the state change signal, starting from the decoupled state of the freewheel device, to operate the electrical machine in a pre-synchronization phase in which the rotation speed of the electrical machine is regulated to a target rotation speed, lying below an actual rotation speed of the output, and on reaching the nominal rotation speed below the target rotation speed, the coupling phase is implemented in which the target rotation speed is increased and the transition to the coupled state of the freewheel device is performed.
